(19) United States
(12) Patent Application Publication
(10) Pub. No.: US 2026/0204795 A1
(43) Pub. Date: Jul. 16, 2026

(54) LOW-PROFILE METASURFACE REFLECTORS

(71) Applicant: 3M INNOVATIVE PROPERTIES COMPANY, St. Paul, MN (US)

(72) Inventors: Ivan Lemesh, Minneapolis, MN (US); Kevin W. Gotrik, Hudson, WI (US); Michael S. Graff, Woodbury, MN (US); Charles A. Hill, Saint Paul, MN (US); Lynn E. Lorimor, Minneapolis, MN (US); Koji Saito, Higashine-City (JP); Matthew S. Stay, Bloomington, MN (US); John J. Sullivan, Hudson, WI (US)

(21) Appl. No.: 19/136,439

(22) PCT Filed: Dec. 5, 2023
(86) PCT No.: PCT/IB2023/062272

§ 371 Date: Jun. 6, 2025

Related U.S. Application Data
(60) Provisional application No. 63/431,404, filed on Dec. 9, 2022.

(51) Int. Cl. H01Q 15/00; H01Q 3/46

(52) U.S. Cl. CPC H01Q 15/0026; H01Q 3/46

(57) ABSTRACT

An integral optical construction includes a frequency selective reflective construction disposed between a decorative cover layer and a ground metallic layer. The ground metallic layer is configured to reflect and/or absorb a radiofrequency electromagnetic wave transmitted by the decorative cover layer and the frequency selective reflective construction. Each of the frequency selective reflective constructions includes a frequency selective surface layer disposed on a multilayer stack and having a group of metallic elements repeating across the frequency selective surface layer to form an array. The integral optical construction reflects a collimated incident RF electromagnetic wave having a wavelength in a range from 1.0 mm to 10 cm and incident at an incident angle as a collimated reflected wave at a reflected angle different from the incident angle. For a normally incident light having a first visible wavelength, the frequency selective reflective construction has an optical transmittance of greater than 50%.

### SUMMARY

In some aspects of the present description, an integral optical construction is provided, the integral optical construction including at least one frequency selective reflective construction disposed between a decorative cover layer and a ground metallic layer. The decorative cover layer is configured to display at least one of an image and information to a viewer. The ground metallic layer is configured to substantially reflect and/or substantially absorb a radiofrequency (RF) electromagnetic wave transmitted by the decorative cover layer and the at least one frequency selective reflective construction. Each of the at least one frequency selective reflective constructions having a frequency selective surface (FSS) layer disposed on a multilayer stack and including a group of metallic elements repeating across the FSS layer to form an array of the group of metallic elements. The multilayer stack includes a plurality of alternating different first dielectric and second adhesive layers. The integral optical construction is configured to reflect, by one of constructive and destructive interference, a substantially collimated incident RF electromagnetic wave having a free-space wavelength in a range from about 1.0 mm to about 20 cm and incident at an incident angle as a substantially collimated reflected wave at a reflected angle different from the incident angle. For a substantially normally incident light having a first visible wavelength in a visible wavelength range extending from about 420 nm to about 680 nm, the at least one frequency selective reflective construction has an optical transmittance of greater than about 50%.

In some aspects of the present description, a wireless system is provided, the wireless system including spaced-apart first and second transceivers, and any of the integral optical constructions described herein. Each of the spaced-apart first and second transceivers are configured to at least one of emit and receive an RF electromagnetic wave having the free-space wavelength. The integral optical construction is configured to receive the RF electromagnetic wave emitted by one of the first and second transceivers and reflect at least a portion of the received RF electromagnetic wave to the other one of the first and second transceivers. An incident angle of the received RF electromagnetic wave and a reflected angle of the reflected RF electromagnetic wave differ by at least about 5 degrees.

In some aspects of the present description, an integral optical construction is provided, the integral optical construction configured to be mounted on a support and covered by a decorative cover layer which is configured to display at least one of an image and information to a viewer. The integral optical construction includes a multilayer stack disposed between a frequency selective surface (FSS) layer configured to face the decorative cover layer and a wave-reflecting layer configured to face the support. The FSS layer includes a plurality of discrete spaced-apart electrically isolated, electrically conductive elements arranged along a width and a length of (i.e., in the plane formed by) the FSS layer. The multilayer stack includes at least two non-adhesive dielectric layers bonded to each other by at least one adhesive (100) layer. The integral optical construction is configured to reflect, by one of constructive and destructive interference, a substantially collimated incident RF electromagnetic wave having a free-space wavelength in a range from about 1.0 mm to about 300.0 cm and incident at an incident angle as a substantially collimated reflected wave at a reflected angle different from the incident angle. When the integral optical construction is mounted on the support and covered by the decorative cover layer so that the FSS layer faces the decorative cover layer and the wave-absorbing layer faces the support, the wave-reflecting layer is configured to substantially reflect an RF electromagnetic wave that is transmitted by the decorative cover layer, the FSS layer, and the multilayer stack.

### BRIEF DESCRIPTION OF THE DRAWINGS

FIG. 1 is a side view of a construction which includes an integral optical construction, in accordance with an embodiment of the present description;

FIGS. 2A-2B provide views of a frequency selective reflective construction, in accordance with an embodiment of the present description;

FIG. 3 is a side view of an integral optical construction, in accordance with an embodiment of the present description;

FIGS. 4A-4C define angles of incidence for light rays incident on optical constructions, in accordance with an embodiment of the present description;

FIG. 5 is a top, plan view of a ground metallic layer including a metallic mesh layer, in accordance with an embodiment of the present description;

FIGS. 6A-6M define various types of images and information that may be displayed on a decorative cover layer, in accordance with an embodiment of the present description;

FIG. 7 is a perspective view of an operational use of an integral optical construction, in accordance with an embodiment of the present description;

FIGS. 8A-8J define shapes and forms of components of an integral optical construction, in accordance with an embodiment of the present description;

FIG. 9 is a side view illustrating how metallic elements of an integral optical construction may be partially embedded in an adjacent layer, in accordance with an embodiment of the present description;

FIG. 10 includes a side view of an integral optical construction comprising a multilayer stack, in accordance with an alternate embodiment of the present description; and

FIG. 11 is a top, plan view of a wireless system, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

The demand for higher communication frequencies is rapidly increasing. Mobile and wireless communications are gradually shifting from sub-5 GHz frequencies (e.g., standard LTE, 5G NR FR1, and Wi-Fi 6 protocols) into deep microwave and mm-wave spectrum frequencies (e.g., 5G NR FR2, 6G for mobile and Wi-Fi 7, Wi-Gig for wireless networks). Unfortunately, associated with these higher frequencies is lower efficiency signal propagation due to the free-space path losses (caused by a diminished effective receiver aperture size) as well as increased air absorption. Such deteriorated transmission, as well as signal shadowing effects typically present in congested urban indoor and outdoor environments, requires a stark increase in the number of powered components such as active antenna nodes and repeaters. This is expensive in terms of both increased installation costs and increased power consumption.

Studies have shown that passive non-powered components, such as metasurface-based (or equivalently, Frequency Selective Surface-based or FSS-based) reflectarrays and diffuse reflectors can improve network coverage and do so while conforming to the architectural profile of the environment. These reflectors are typically recommended for patching network coverage holes but can also be used for redirecting signal that would otherwise leak outside of the designated network boundaries. However, for a noticeable effect on the overall network quality, these solutions need to cover a large surface area (for an individual reflector, this translates to the aperture size being comparable or, at least, not significantly smaller than the antenna-to-reflector distance) so must be supplied in large quantities and, preferably, in a low-cost, roll-based, and flexible thin film format, with low profile and without significant sacrifices in their RF performance.

According to some aspects of the present description, an integral optical construction is configured to address these system requirements. In some embodiments, an integral optical construction includes at least one frequency selective reflective construction disposed between a decorative cover layer and a ground metallic layer. In some embodiments, the decorative cover layer may be configured to display at least one of an image and information (e.g., text, images, maps, logos, etc.) to a viewer. In some embodiments, the ground metallic layer may be configured to substantially reflect and/or substantially absorb a radiofrequency (RF) electromagnetic wave transmitted by (i.e., allowed to pass through) the decorative cover layer and the at least one frequency selective reflective construction. In some embodiments, each of the at least one frequency selective reflective constructions may include a frequency selective surface (FSS) layer disposed on a multilayer stack having a group of metallic elements repeating across (e.g., across an xy-plane defined by) the FSS layer to form an array of the group of metallic elements. In some embodiments, the multilayer stack may include a plurality of alternating different first dielectric and second adhesive layers.

In some embodiments, the integral optical construction is configured to reflect, by one of constructive and destructive interference, a substantially collimated incident RF electromagnetic wave having a free-space wavelength in a range from about 1.0 mm to about 40 cm, or to about 20 cm, or to about 10 cm and incident at an incident angle q1 as a substantially collimated reflected wave at a reflected angle q2 different from the incident angle q1. In some embodiments, a difference between the incident and reflected angles may be greater than about 5 degrees, or greater than about 10 degrees, or greater than about 15 degrees, or greater than about 20 degrees, or greater than about 25 degrees, or greater than about 30 degrees, or greater than about 35 degrees, or greater than about 40 degrees, or greater than about 45 degrees, or greater than about 50 degrees.

In some embodiments, for a substantially normally incident light having a first visible wavelength (e.g., 550 nm) in a visible wavelength range extending from about 420 nm to about 680 nm, the at least one frequency selective reflective construction has an optical transmittance of greater than about 50%, or greater than about 60%, or greater than about 70%, or greater than about 80%.

In some embodiments, the ground metallic layer may be physically and electrically continuous across the integral optical construction, such that for a substantially normally incident light having the first visible wavelength, the ground metallic layer has an optical transmittance of less than about 20%, or less than about 15%, or less than about 10%, or less than about 5%, or less than about 1%, or less than about 0.5%.

In some embodiments, the ground metallic layer may be a metallic mesh layer, the mesh including a plurality of metal traces connected to form a plurality of enclosed open areas, such that for a substantially normally incident light having the first visible wavelength, the ground metallic layer may have an optical transmittance of greater than about 50%, or greater than about 60%, or greater than about 70%, or greater than about 80%.

In some embodiments, the integral optical construction may have an optical transmittance of greater than about 50%, or greater than about 60%, or greater than about 70%, or greater than about 80% for a substantially normally incident light having the first visible wavelength. In some embodiments, for a substantially normally incident light having the first visible wavelength, the decorative cover layer may have an optical transmittance of greater than about 50%, or greater than about 60%, or greater than about 70%, or greater than about 80%.

In some embodiments, any specular reflectance of the substantially collimated incident RF electromagnetic wave by the integral optical construction may be less than about 90%, or less than about 80%, or less than about 70%, or less than about 60%, or less than about 50%, or less than about 40%, or less than about 30%, or less than about 20%, or less than about 15%, or less than about 10%, or less than about 8%, or less than about 6%, or less than about 4%, or less than about 2%, or less than about 1%, or less than about 0.5%, or less than about 0.1%. In some embodiments, any reflectance of the substantially collimated incident RF electromagnetic wave by the integral optical construction along directions other than a direction of the substantially collimated reflected wave may be less than about 20%, or less than about 15%, or less than about 10%, or less than about 8%, or less than about 6%, or less than about 4%, or less than about 2%, or less than about 1%, or less than about 0.5%, or less than about 0.1%.

In some embodiments, the at least the image displayed by the decorative cover layer may include one or more of a blue color, a black color, a white color, a green color, a yellow color, a brown color, and a red color, and any other color that may at least partially be visible to the viewer. In some embodiments, the at least the image displayed by the decorative cover layer may include an image of one or more of an object, a solid color, a pattern, a scenery, a person, and an animal. In some embodiments, the at least the image displayed by the decorative cover layer may include at least one of a logo, a map, a sign, and a symbol. In some embodiments, the at least the information displayed by the decorative cover layer may include one or more of a letter, a word, and a number.

In some embodiments, the at least one frequency selective reflective construction may include at least two frequency selective reflective constructions. In some such embodiments, the groups of metallic elements in the at least two frequency selective reflective constructions are aligned with each other in a one-to-one correspondence. In some such embodiments, the metallic elements in the aligned groups of metallic elements in the at least two frequency selective reflective constructions are aligned with each other in a one-to-one correspondence.

In some embodiments, the metallic elements in the group of metallic elements form a regular array of the metallic elements. In some embodiments, the array of the group of metallic elements is a regular array. In some embodiments, a regular array may be defined to include a regular (e.g., periodic) repetition of a “unit cell”, wherein the arrangement within the unit cell itself of metallic elements may be one or more of non-regular, random, and non-periodic. In some embodiments, the arrangement within the unit cell of metallic elements may be linear or non-linear (e.g., arranged in a circular, elliptic paraboloid, or other non-linear arrangement).

In some embodiments, the integral optical construction may be configured to be attached to a support surface so that the decorative cover layer faces away from the support surface. In some such embodiments, the support surface may be an exterior surface of a rigid support. In some such embodiments, the rigid support may be a wall, a door, a window, or another surface of a building. In some such embodiments, the wall may be one of a ceiling wall, a floor wall, or a side wall.

In some embodiments, a construction may include any of the integral optical constructions described herein attached to a rigid support such that the decorative cover layer faces away from the rigid support. For example, in some embodiments, the rigid support may be a wall (including a ceiling wall, a floor wall, or a side wall), a door, or a window of a building. In some embodiments, the integral optical construction may be attached to the rigid support via an adhesive layer. In some such embodiments, the adhesive layer is a removable adhesive layer so that the integral optical construction and the adhesive layer may be removed from the rigid support with little or no damage to the rigid support. In some such embodiments, the adhesive layer may be a repositionable adhesive layer such that after applying the repositionable adhesive layer to a first position on the rigid support, the repositionable adhesive layer may be transferred to a different second position on the rigid support with little or no damage to the rigid support and the repositionable adhesive layer. In some such embodiments, applying pressure to the repositionable adhesive layer while in the second position results in a substantially permanent bond between the integral optical construction and the rigid support.

In some embodiments, the metallic elements in the group of metallic elements may include one or more of gold, silver, copper, aluminum, and titanium. In some embodiments, a shape of at least one of the metallic elements in the group of metallic elements may be one of a disk, a cube, a rectangular parallelepiped, and a right prism. In some embodiments, at least one of the metallic elements in the group of metallic elements may be an annulus. In some such embodiments, the annulus may have a circular shape, or an oval shape, or a polygonal shape, or a curvilinear shape, or a piecewise linear shape, or a piecewise curved shape, an any other appropriate shape. In some such embodiments, an average thickness of a wall of the annulus may be between about 10 microns and about 2.5 cm. In some embodiments, the metallic elements in the group of metallic elements have a thickness (e.g., a z-axis of the integral optical construction) in a range from about 10 nm to about 1 mm. In some embodiments, the metallic elements in the group of metallic elements may have a maximum lateral dimension (e.g., an xy-plane of the integral optical construction) in a range from about 10 nm to about 5 cm. In some embodiments, at least one of the metallic elements in the group of metallic elements may be at least partially pressed into an adjacent layer so that the at least one of the metallic elements is at least partially embedded in the adjacent layer. In some such embodiments, the adjacent layer may be one of the first dielectric layers in the plurality of alternating different first dielectric and second adhesive layers.

In some embodiments, the second adhesive layers in the plurality of alternating different first dielectric and second adhesive layers may include one or more of a natural or synthetic rubber-based pressure sensitive adhesive, an acrylic pressure sensitive adhesive, a vinyl alkyl ether pressure sensitive adhesive, a silicone pressure sensitive adhesive, a polyester pressure sensitive adhesive, a polyamide pressure sensitive adhesive, a poly-alpha-olefin pressure sensitive adhesive, a polyurethane pressure sensitive adhesive, and a styrenic block copolymer based pressure sensitive adhesive. In some embodiments, the second adhesive layers in the plurality of alternating different first dielectric and second adhesive layers may include one or more of an organic solvent-based adhesive, a water-based emulsion adhesive, a hot melt adhesive, and an actinic radiation curable adhesive. In some embodiments, the first dielectric layers may include one or more of a polyethylene terephthalate (PET), a polyethylene naphthalate (PEN), an acrylic-based polymer, a butyrate-based polymer, a polycarbonate, a polycarbonate copolymers, a polyurethane, a polyvinyl chloride (PVC), a polyimide (PI), a polyethersulfone, a polyethylene, a polypropylene, a polylactic acid, a fluoro-based polymer, or a co-PET, a polyvinylidene fluoride-based polymer, a terpolymer-based polymer, a tetrafluoroethylene-based polymer, a hexafluoropropylene-based polymer, and a vinylidene fluoride-based polymer.

In some embodiments, the decorative cover layer may include a plurality of electrically conductive particles dispersed therein. In some such embodiments, the electrically conductive particles may include one or more of aluminum, iron, nickel, silver, silica, silicates, alumina, glass, calcium carbonate, titanium dioxide, zinc oxide, copper oxide, and barium titanate. In some such embodiments, an average size of the electrically conductive particles may be less than about 10% of the free-space wavelength.

According to some aspects of the present description, a wireless system may include spaced-apart first and second transceivers and any of the embodiments of integral optical constructions described herein. In some such embodiments, the spaced-apart first and second transceivers may be configured to at least one of emit and receive an RF electromagnetic wave having the free-space wavelength. In some such embodiments, the integral optical construction may be configured to receive the RF electromagnetic wave emitted by one of the first and second transceivers and reflect at least a portion of the received RF electromagnetic wave to the other one of the first and second transceivers. In some such embodiments, an incident angle a1 of the received RF electromagnetic wave and a reflected angle a2 of the reflected RF electromagnetic wave may differ by at least about 5 degrees, or at least about 10 degrees, or at least about 15 degrees, or at least about 20 degrees, or at least about 25 degrees, or at least about 30 degrees, or at least about 35 degrees, or at least about 40 degrees, or at least about 45 degrees, or at least about 50 degrees. In some such embodiments, at least one of the first and second transceivers may include one or more of a signal transmitting tower, a signal receiving tower, a mobile communication device, a repeater, and an antenna.

In some embodiments, the integral optical construction may include at least one of a flame retarding material. In some such embodiments, the flame retarding material may include at least one of ammonium polyphosphate, antimony trioxide, zinc boride, aluminum hydroxide, calcium carbonate, magnesium hydroxide, and polybrominated diphenyl ether. In some such embodiments, at least one of the decorative cover layer, at least one of the first dielectric layers, and at least one of the second adhesive layers, may include at least some of the flame retarding material.

In some embodiments, the ground metallic layer may be configured to primarily reflect the RF electromagnetic wave transmitted by the decorative cover layer and the at least one frequency selective reflective construction. In some such embodiments, the ground metallic layer may be configured to reflect at least 60%, or at least 70%, or at least 80%, or at least 90%, or at least 95% of the RF electromagnetic wave that is transmitted by the decorative cover layer and the at least one frequency selective reflective construction.

In some embodiments, the ground metallic layer may be configured to absorb at most 10% or at most 8%, or at most 6%, or at most 4%, or at most 2%, or at most 1%, or at most 0.5% of the RF electromagnetic wave that is transmitted by the decorative cover layer and the at least one frequency selective reflective construction.

In some embodiments, the ground metallic layer may be configured to transmit at most 10%, or at most 8%, or at most 6%, or at most 4%, or at most 2%, or at most 1%, or at most 0.5% of the RF electromagnetic wave that is transmitted by the decorative cover layer and the at least one frequency selective reflective construction.

In some embodiments, the integral optical construction may be configured to reflect at least 20%, or at least 30%, or at least 40%, or at least 50%, or at least 60%, or at least 70%, or at least 80%, or at least 90%, or at least 95% of the substantially collimated incident RF electromagnetic wave as the substantially collimated reflected wave. In some embodiments, the integral optical construction may be configured to absorb at most 10%, or at most 8%, or at most 6%, or at most 4%, or at most 2%, or at most 1%, or at most 0.5% of the substantially collimated incident RF electromagnetic wave. In some embodiments, the integral optical construction may be configured to transmit at most 10%, or at most 8%, or at most 6%, or at most 4%, or at most 2%, or at most 1%, or at most 0.5% of the substantially collimated incident RF electromagnetic wave.

According to some aspects of the present description, an integral optical construction configured to be mounted on a support (e.g., a side wall, a ceiling, a floor, etc.) and covered by a decorative cover layer includes a multilayer stack disposed between a frequency selective surface (FSS) layer and a wave-reflecting layer. In some embodiments, the cover layer may be configured to display at least one of an image and information to a viewer. In some embodiments, the FSS layer may be configured to face the decorative cover layer, and the wave-reflecting layer may be configured to face the support.

In some embodiments, the FSS layer may include a plurality of discrete spaced-apart electrically isolated electrically conductive elements arranged along a width (e.g., an x-axis) and a length (e.g., a y-axis) of the FSS layer. In some embodiments, the multilayer stack may include at least two non-adhesive dielectric layers bonded to each other by at least one adhesive layer.

In some embodiments, the integral optical construction may be configured to reflect, by one of constructive and destructive interference, a substantially collimated incident RF electromagnetic wave having a free-space wavelength in a range from about 1.0 mm to about 300.0 cm and incident at an incident angle q1 as a substantially collimated reflected wave at a reflected angle q2 different from the incident angle. In some such embodiments, when the integral optical construction is mounted on the support and covered by the decorative cover layer so that the FSS layer faces the decorative cover layer and the wave-absorbing layer faces the support, the wave-reflecting layer may be configured to substantially reflect an RF electromagnetic wave that is transmitted by the decorative cover layer, the FSS layer, and the multilayer stack. In some embodiments, the integral optical construction may be configured to reflect at least 60%, or at least 70%, or at least 80%, or at least 90%, or at least 95% of the substantially collimated incident RF electromagnetic wave as the substantially collimated reflected wave.

In some embodiments, the conductive elements may be arranged regularly along at least one of the width and the length of the FSS layer. In some embodiments, the electrically conductive elements may be metallic elements. In some embodiments, the electrically conductive elements may include one or more of indium tin oxide, zinc oxide, and an electrically conductive polymer.

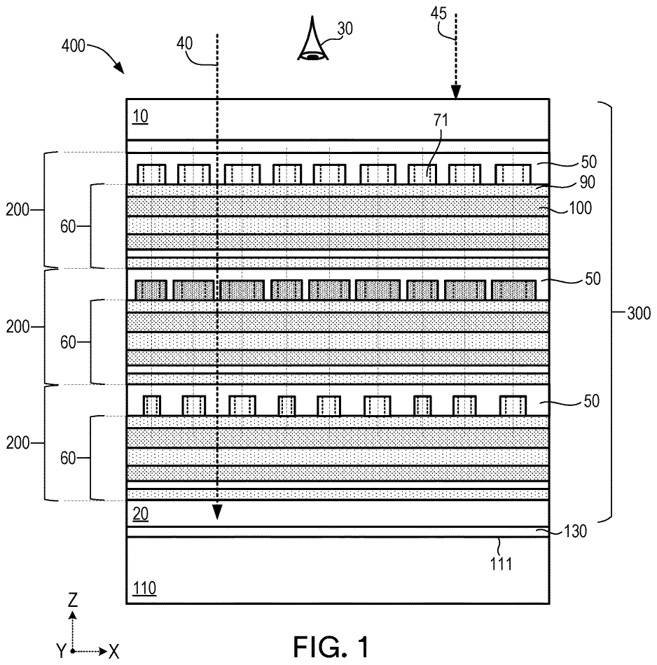

Turning now to the figures, FIG. 1 is a side view of a construction which includes an embodiment of an integral optical construction according to the present description. In some embodiments, construction 400 includes an integral optical construction 300 attached to a rigid support 110. In some embodiments, rigid support may be a wall (e.g., a ceiling wall, a floor wall, or a side wall), a door, or a window of a building. In some embodiments, integral optical construction 300 may be attached to a support surface 111 of a rigid support 110 via an adhesive layer 130.

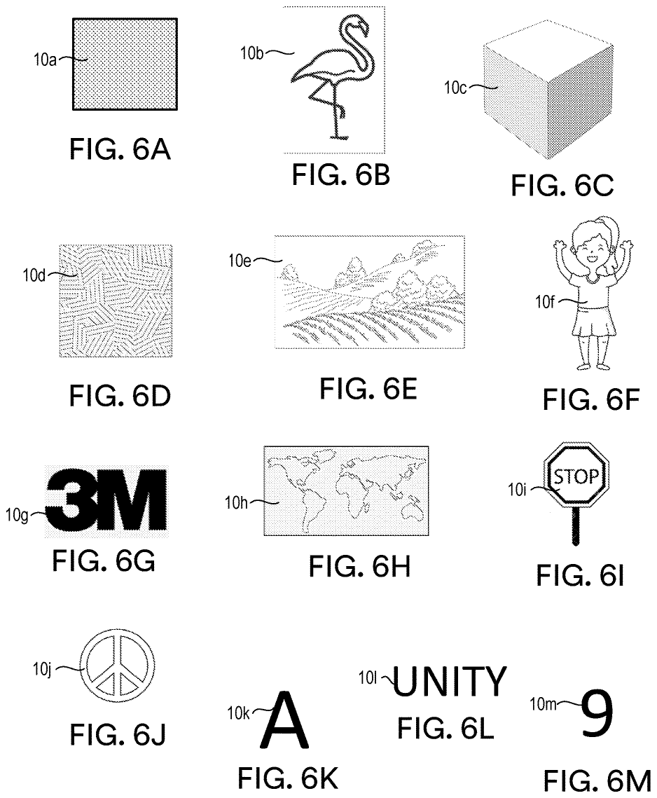

In some embodiments, integral optical construction 300 may include at least 1, or at least 2, or at least 3, or at least 5, or at least 10 frequency selective reflective constructions 200 disposed between a decorative cover layer 10 and a ground metallic layer 20. In some embodiments, decorative cover layer 10 may be configured to display at least one of an image and information to a viewer 30 (e.g., see FIGS. 6A-6M). In some embodiments, the ground metallic layer may be configured to substantially at least one of reflect and absorb a radiofrequency (RF) electromagnetic wave 40 transmitted by (i.e., allowed to pass through) the decorative cover layer 10 and the at least one frequency selective reflective construction 200.

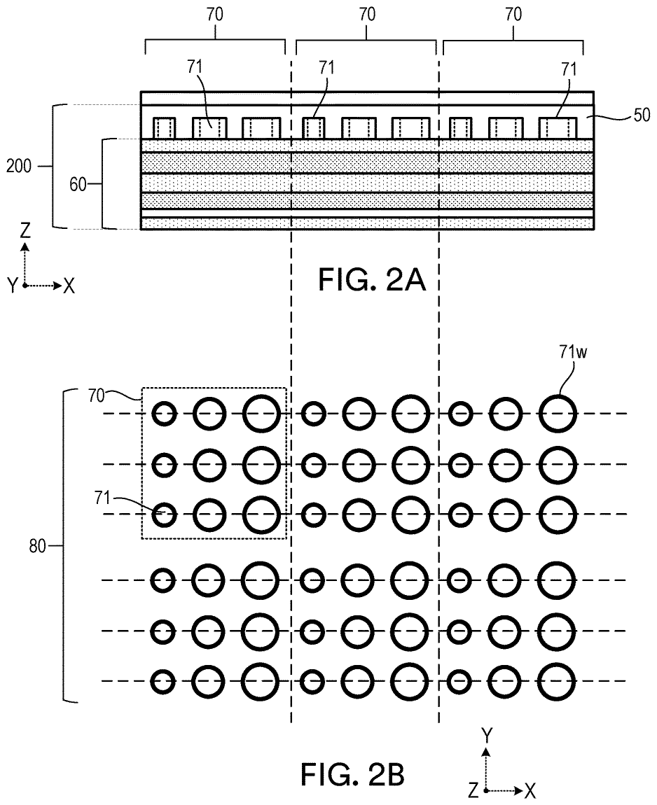

In some embodiments, each of the frequency selective reflective constructions 200 may include a frequency selective surface (FSS) layer 50 disposed on a multilayer stack 60. In some embodiments, FSS layer 50 may include groups of metallic elements 71 repeating across FSS layer 50 (e.g., in an x-y plane as defined in FIG. 1) to form an array of the group of metallic elements 71. Additional details on the arrangement of metallic elements is provided in FIGS. 2A-2B.

In some embodiments, multilayer stack 60 may include a plurality of alternating different first dielectric layers 90 and second adhesive layers 100. In some embodiments, each integral optical construction 300 may be configured to reflect, by one of constructive and destructive interference, a substantially collimated incident RF electromagnetic wave having a free-space wavelength as a substantially collimated reflected wave at a reflected angle different from the incident angle. In some embodiments, for a substantially normally incident light having a first visible wavelength (e.g., 550 nm) in a visible wavelength range extending from about 420 nm to about 680 nm, the at least one frequency selective reflective construction 200 may have an optical transmittance of greater than about 50%, or greater than about 60%, or greater than about 70%, or greater than about 80%.

In some embodiments, integral optical construction 300 may have an optical transmittance of greater than about 50%, or greater than about 60%, or greater than about 70%, or greater than about 80% for a substantially normally incident light 45 having the first visible wavelength. In some embodiments, for substantially normally incident light 45 having the first visible wavelength, the decorative cover layer may have an optical transmittance of greater than about 50%, or greater than about 60%, or greater than about 70%, or greater than about 80%.

FIGS. 2A-2B provide additional details on the embodiment of a frequency selective reflective construction 200 of FIG. 1 and may share like-numbered elements with FIG. 1, which are assumed to have the same function unless specifically stated otherwise herein. FIG. 2A is a side schematic view of frequency selective reflective construction 200, and FIG. 2B provides a top, plan view showing one possible arrangement of groups 70 of metallic elements 71. In this embodiment, as shown in FIG. 2B, metallic elements 71 are shown having a circular, annulus shape. In some such embodiments, an average thickness of a wall 71w of the annulus may be between about 10 microns to about 2.5 cm.

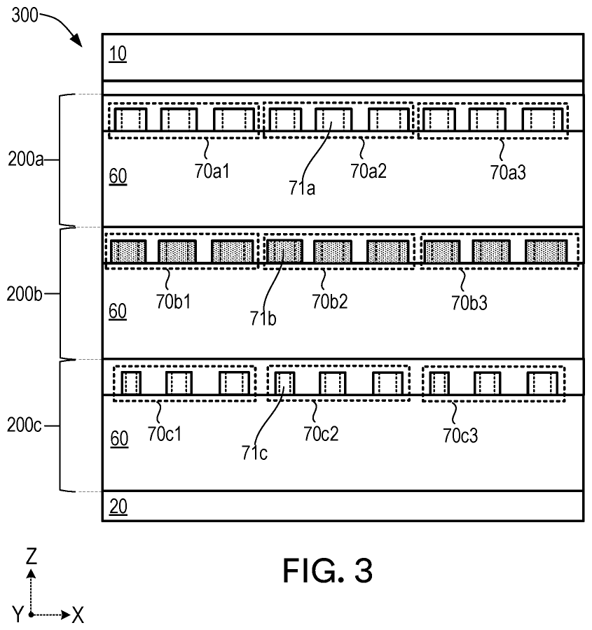

FIG. 3 provides an additional side view of an embodiment of an integral optical construction, such as integral optical construction 300 of FIG. 1. As discussed elsewhere herein, in some embodiments, integral optical construction 300 may include at least two frequency selective reflective constructions 200, such as 200a, 200b, and 200c as shown in FIG. 3. Each frequency selective reflective construction 200 may include groups 70 of metallic elements 71 such that the groups 70 of metallic elements 71 in each frequency selective reflective construction 200 are aligned with each other in a one-to-one correspondence. For example, metallic elements 71a of group 70a1 of frequency selective reflective construction 200a may be aligned in a one-to-one correspondence with metallic elements 71b of group 70b1 of frequency selective reflective construction 200b, and with metallic elements 71c of group 70c1 of frequency selective reflective construction 200c. The same one-to-one correspondence may apply to groups 70a2, 70b2, and 70c2, as well as to groups 70a3, 70b3, and 70c3.

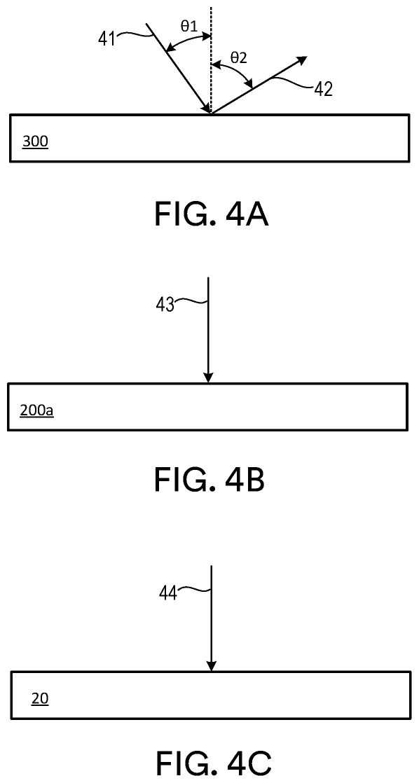

FIGS. 4A-4C are provided primarily for discussion purposes and for defining angles of incidence for light rays incident on optical constructions. FIG. 4A, for example, shows a substantially collimated incident RF electromagnetic wave 41 having a free-space wavelength in a range from about 1.0 mm to about 40 cm, or to about 20 cm, or to about 10 cm and incident on integral optical construction 300 at an incident angle θ1 reflected as a substantially collimated reflected wave 42 at a reflected angle θ2 that is different from incident angle θ1.

FIG. 4B shows a substantially normally incident light 43 (as discussed elsewhere herein, having a first visible wavelength in a visible wavelength range extending from about 420 nm to about 680 nm) incident on frequency selective reflective construction 200a, such that frequency selective reflective construction 200a has an optical transmittance of greater than about 50%, or greater than about 60%, or greater than about 70%, or greater than about 80%.

FIG. 4C shows a substantially normally incident light 44 having the first visible wavelength incident on ground metallic layer 20 with is physically and electrically continuous, such that light 44 has an optical transmittance of less than about 20%, or less than about 15%, or less than about 10%, or less than about 5%, or less than about 1%, or less than about 0.5% (that is, in some embodiments, light 44 is substantially reflected by ground metallic layer 20).

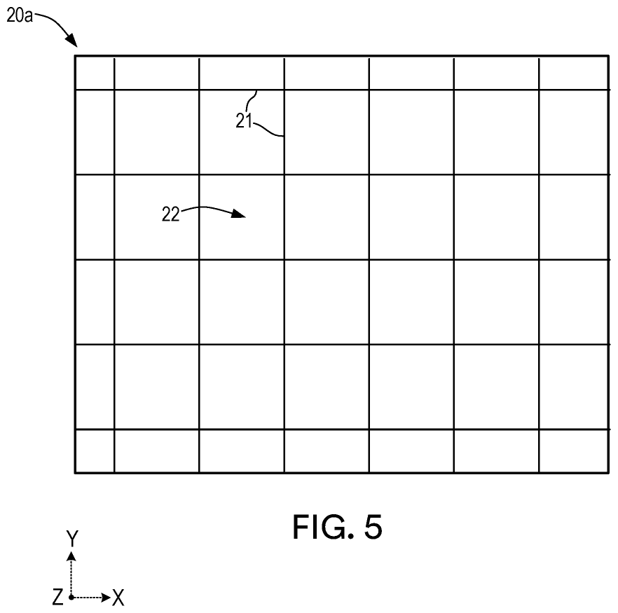

FIG. 5 is a top, plan view of an embodiment of a ground metallic layer including a metallic mesh layer. In this embodiment, the ground metallic layer (such as ground metallic layer 20 of FIG. 1) may be a metallic mesh layer 20a, including a plurality of metal traces 21 connected to form a plurality of enclosed open areas 22. In such a mesh layer embodiment, for a substantially normally incident light 44 (see FIG. 4C) having the first visible wavelength, the ground metallic layer 20a may have an optical transmittance of greater than about 50%, or greater than about 60%, or greater than about 70%, or greater than about 80%.

FIGS. 6A-6M provide additional detail on various types of images and information that may be displayed on a decorative cover layer, such as decorative cover layer 10 of FIG. 1. An image displayed on decorative cover layer 10 (see FIG. 1) may be a solid color (10a of FIG. 6A) or may be one or more of a blue color, a black color, a white color, a green color, a yellow color, a brown color, and a red color, and any other color that may at least partially be visible to the viewer. In some embodiments, the image displayed on decorative cover layer 10 may include one or more of an animal (10b of FIG. 6B), an object (10c of FIG. 6C), a pattern (10d of FIG. 6D), a scenery (10e of FIG. 6E), a person (10f of FIG. 6F), a logo (10g of FIG. 6G), a map (10h of FIG. 6H), a sign (10i of FIG. 6I), and a symbol (10j of FIG. 6J). In some embodiments, the information provided on decorative cover layer 10 may include one or more of a letter (10k of FIG. 6K), a word (101 of FIG. 6L), and a number (10m of FIG. 6M). In some embodiments, decorative cover layer 10 may include any appropriate combination of images and information.

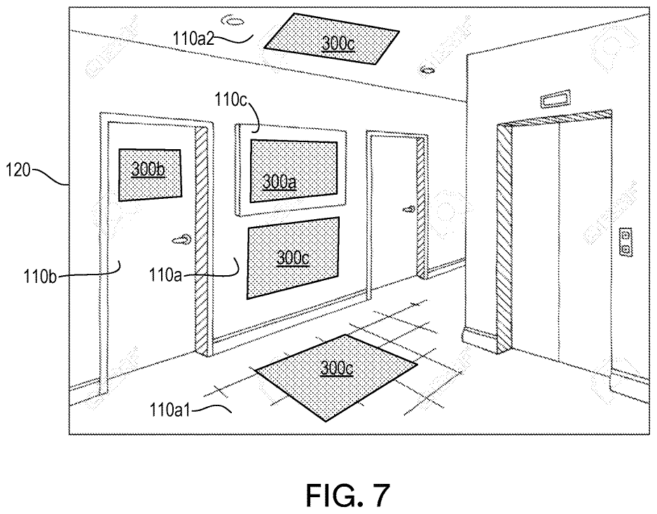

FIG. 7 is a perspective view of an operational use of an embodiment of the integral optical construction described herein. FIG. 7 shows a view of an interior of a building 120. In operation use, the integral optical construction 300 of FIG. 1 may be attached to a support surface 111 (e.g., an exterior surface) of a rigid support 110 (FIG. 1). For example, in some embodiments, integral optical construction 300a may be attached to a window 110c, integral optical construction 300b may be attached to a door 110b, and integral optical construction 300c may be attached to a wall 110a. In some embodiments, a wall 110a may include a ceiling (i.e., a ceiling wall) 110a2, a floor (i.e., a floor wall) 110a1, or a side wall 110a. In some embodiments, the integral optical construction 300 is disposed between the support surface 111 and a decorative cover layer 10 with the decorative cover layer 10 facing out away from the support surface 111 into an interior of the building 120.

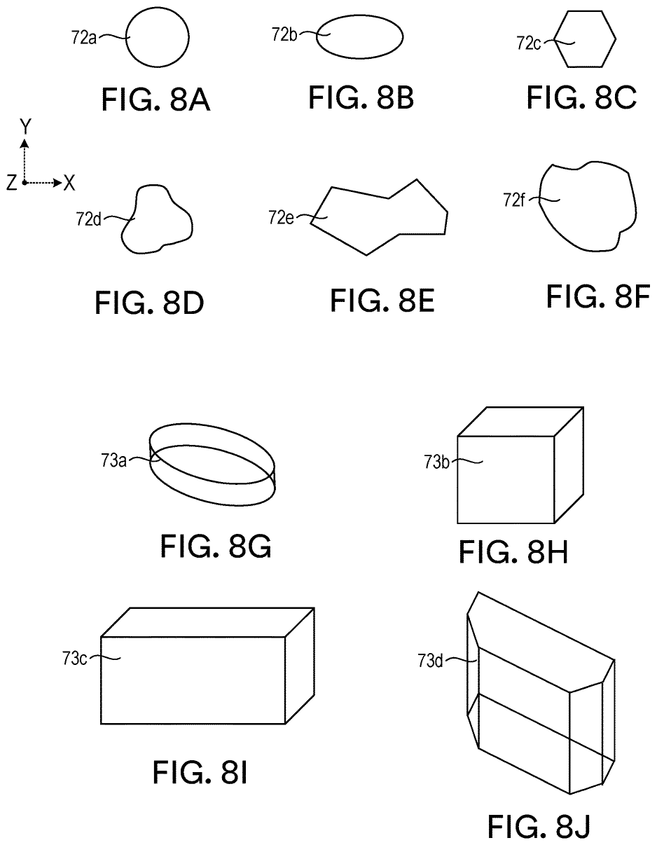

FIGS. 8A-8J define additional shapes and forms of metallic elements 71 of an integral optical construction of FIG. 1. As stated elsewhere herein, in some embodiments, at least one of the metallic elements 71 in the group 70 of metallic elements may be an annulus (i.e., a ring-shaped object, structure, or region). In some such embodiments, the annulus may have a circular shape (72a of FIG. 8A). In some such embodiments, the annulus may have an oval shape (72b of FIG. 8B). In some such embodiments, the annulus may have a polygonal shape (72c of FIG. 8C). In some such embodiments, the annulus may have a curvilinear shape (72d of FIG. 8D). In some such embodiments, the annulus may have a piecewise linear shape (72e of FIG. 8E). In some such embodiments, the annulus may have a piecewise curved shape (72f of FIG. 8F). In some embodiments, a shape of at least one of the metallic elements 71 may be one of a disk (73a of FIG. 8G), a cube (73b of FIG. 8H), a rectangular parallelepiped (73c of FIG. 8I), and a right prism (73d of FIG. 8J).

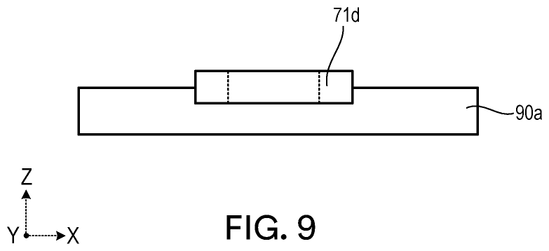

FIG. 9 is a side view illustrating how one or more metallic elements 71 of an integral optical construction 300 (FIG. 1) may be partially embedded in an adjacent layer. For example, as shown in FIG. 9, metallic element 71d may be at least partially embedded in (partially pressed into) adjacent dielectric layer 90a.

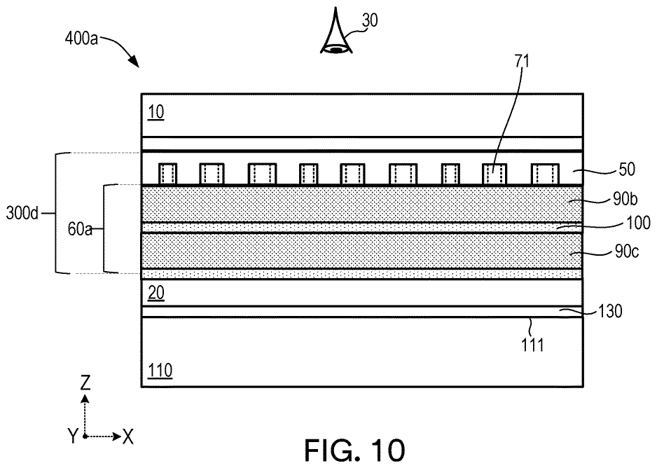

FIG. 10 includes a side view of an alternate embodiment of an integral optical construction comprising a multilayer stack. A construction 400a includes an integral optical construction 300d disposed between a decorative cover layer 10 and a support 110. In some embodiments, the integral optical construction 300d may be attached to support surface 111 of support 110 such that the decorative cover layer faces away from support surface 111.

In some embodiments, the integral optical construction 300d includes a multilayer stack 60a disposed between a frequency selective surface (FSS) layer 50 configured to face decorative cover layer 10 and a wave-reflecting layer 20 configured to face support 110. In some embodiments, the FSS layer may include a plurality of discrete spaced-apart, electrically isolated, electrically conductive elements 71 arranged along a width (e.g., the x-axis defined in FIG. 10) and a length (e.g., the y-axis of FIG. 10) of the FSS layer 50. In some embodiments, the conductive elements 71 may be arranged regularly along at least one of the width and the length of the FSS layer 50. In some embodiments, the electrically conductive elements 71 may include one or more of indium tin oxide, zinc oxide, and an electrically conductive polymer.

In some embodiments, the multilayer stack 60a may include at least two non-adhesive dielectric layers 90b, 90c bonded to each other by at least one adhesive 100 layer. In some embodiments, integral optical construction 300d may be configured to reflect, by one of constructive and destructive interference, a substantially collimated incident RF electromagnetic wave having a free-space wavelength in a range from about 1.0 mm to about 300.0 cm and incident at an incident angle as a substantially collimated reflected wave at a reflected angle different from the incident angle. In some embodiments, when integral optical construction 300d is mounted on support 110 and covered by decorative cover layer 10 so that the FSS layer 50 faces decorative cover layer 10 and the wave-reflecting layer 20 faces the support, the wave-reflecting layer 20 is configured to substantially reflect an RF electromagnetic wave that is transmitted by the decorative cover layer, the FSS layer, and the multilayer stack. In some embodiments, the integral optical construction 300d may be configured to reflect at least 60%, or at least 70%, or at least 80%, or at least 90%, or at least 95% of the substantially collimated incident RF electromagnetic wave as the substantially collimated reflected wave.

In some embodiments, integral optical construction 300d may be attached to a support surface 111 of a rigid support 110 via an adhesive layer 130.

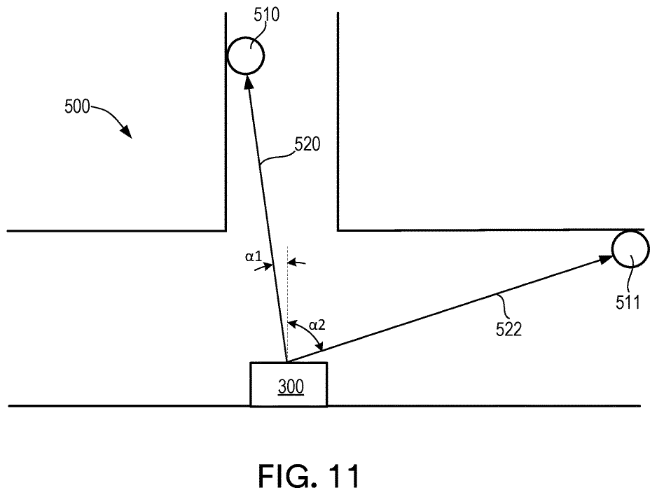

Finally, FIG. 11 is a top, plan view of one embodiment of a wireless system, according to the present description. In some embodiments, wireless system 500 may include spaced-apart first 510 and second 511 transceivers and an integral optical construction such as integral optical construction 300 of FIG. 1 or any of the integral optical construction embodiments described herein. In some embodiments, each of the first 510 and second 511 transceivers may be configured to at least one of emit and receive an RF electromagnetic wave 520, 522 having the free-space wavelength. In some embodiments, integral optical construction 300 may be configured to receive the RF electromagnetic wave 520, 522 emitted by one of the first 510 and second 511 transceivers and reflect at least a portion of the received RF electromagnetic wave 520, 522 to the other one of the first 510 and second 511 transceivers. In some embodiments, an incident angle a1 of the received RF electromagnetic wave (e.g., wave 520) and a reflected angle a2 of the reflected RF electromagnetic wave (e.g., wave 522) may differ by at least about 5, or at least about 10, or at least about 15, or at least about 20, or at least about 25, or at least about 30, or at least about 35, or at least about 40, or at least about 45, or at least about 50 degrees. In some embodiments, at least one of the first 510 and second 511 transceivers may include one or more of a signal transmitting

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

### Examples

Unless otherwise noted or readily apparent from the context, all parts, percentages, ratios, etc. in the Examples and the rest of the specification are by weight.

The following abbreviations are used in this section: nm=nanometers, μm=micrometers, mm=millimeters, cm=centimeters, m=meters, ft=feet, in=inches, mil=thousandths of an inch, min=minutes, ° C.=degrees Celsius, ° F.=degrees Fahrenheit, GHz=gigahertz, dB=decibels, Dk=dielectric constant, Df=dielectric loss tangent, BCM=billioncubic micrometers. Abbreviations formaterials used in this section, as well as descriptions of the materials, are provided in Table 1.

TABLE 1
Films used in the Examples

| | | Total | Effective | Effective |
|---|---|---|---|---|
| | | thickness | Dk at | Df at |
| | Sample Label | [mm] | 24.7 GHz | 24.7 GHz |
| FILM A | Architectural finish available under the trade | 0.190 | 2.66 | 0.0270 |
| | designation “3M DI-NOC ARCHITECTURAL | | | |
| | FINISHES FINE WOOD FW-1970” from 3M, | | | |
| | Maplewood, MN | | | |
| FILM B | Architectural finish available under the trade | 0.204 | 2.75 | 0.0098 |
| | designation “3M DI-NOC ARCHITECTURAL | | | |
| | FINISHES FINE WOOD FW-1289” from 3M | | | |
| FILM C | Architectural finish available under the trade | 0.201 | 2.88 | 0.0122 |
| | designation “3M DI-NOC ARCHITECTURAL | | | |
| | FINISHES MATTE SERIES STONE ST-1912MT” | | | |
| | from 3M | | | |
| FILM D | Architectural finish available under the trade | 0.208 | 4.49 | 0.0180 |
| | designation “3M DI-NOC ARCHITECTURAL | | | |
| | FINISHES METALLIC HAIRLINE ME-1434” | | | |
| | from 3M | | | |
| FILM E | Architectural finish available under the trade | 0.188 | NM | NM |
| | designation “3M DI-NOC ARCHITECTURAL | | | |
| | FINISHES METALLIC HAIRLINE VM-306” | | | |
| | from 3M | | | |
| FILM F | Architectural finish available under the trade | 0.188 | 2.31 | 0.0070 |
| | designation “3M DI-NOC ARCHITECTURAL | | | |
| | FINISHES E SERIES FINE WOOD FW-1252E | | | |
| | from 3M | | | |
| FILM G | Architectural finish available under the trade | 0.208 | 2.72 | 0.0115 |
| | designation “3M DI-NOC ARCHITECTURAL | | | |
| | FINISHES TEXTILE NU-1792” from 3M | | | |
| FILM H | Graphic Film available under the trade | 0.090 | 2.95 | 0.0140 |
| | designation “3M SCOTCHCAL | | | |
| | ELECTROCUT GRAPHIC FILM 7125-25” | | | |
| | from 3M | | | |
| FILM I | Graphic Film available under the trade | 0.090 | 3.86 | 0.0309 |
| | designation “3M SCOTCHCAL | | | |
| | CONTROLTAC GRAPHIC FILM 180mC-227 | | | |
| | from 3M | | | |
| FILM J | Graphic Film available under the trade | 0.090 | 2.58 | 0.0144 |
| | designation “3M SCOTCHCAL | | | |
| | ELECTROCUT GRAPHIC FILM 7125-56” | | | |
| | from 3M | | | |
| FILM K | Glass finish available under the trade | 0.090 | 2.75 | 0.0117 |
| | designation “3M FASARA GLASS FINISHES | | | |
| | LUNA 6 SH2PCL6” from 3M | | | |
| FILM L | Glass finish available under the trade | 0.080 | 3.08 | 0.0152 |
| | designation “3M FASARA GLASS FINISHES | | | |
| | PRISM SILVER SH2CSPS” from 3M | | | |
| FILM M | Glass finish available under the trade | 0.091 | 2.75 | 0.0139 |
| | designation “3M FASARA GLASS FINISHES | | | |
| | LUCE SH2FGLU” from 3M | | | |
| FILM N | Glass finish available under the trade | 0.078 | 3.08 | 0.0147 |
| | designation “3M FASARA GLASS FINISHES | | | |
| | SHUTIE BLACK SH2BKST” from 3M | | | |
| FILM O | Glass finish available under the trade | 0.075 | NM | NM |
| | designation “3M FASARA GLASS FINISHES | | | |
| | CHAIN MESH REFLECT SH2SICMR” from 3M | | | |
| FILM P | Glass finish available under the trade | 0.075 | NM | NM |
| | designation “3M FASARA GLASS FINISHES | | | |
| | REFLECT RE1SIAR” from 3M | | | |
| FILM Q | Cyclic Olefin Polymer (COP) film with | 0.188 | 2.33 | 0.0004 |
| | thickness 4 mil (102 μm) available under the | | | |
| | trade designation “ZEONEX 480R” from Zeon | | | |
| | Specialty Materials Inc., San Jose, California | | | |
| FILM R | Polyester film available under trade designation | 0.127 | 3.20 | 0.0048 |
| | “MELINEX ST505” from DuPont Teijin Films, | | | |
| | Chester, VA, with a 100 nm Al layer sputter | | | |
| | coated on one side. | | | |
| DLLP | Clear, low profile, polyolefin fastener available | | | |
| | under the trade designation “3M DUAL LOCK | | | |
| | LOW PROFILE RECLOSABLE FASTENER | | | |
| | SJ4580” from 3M | | | |
| PSA | Acrylic pressure sensitive adhesive of 100 parts | 0.020 | | |
| | Butyl Acrylate/Methyl Acrylate/Hydroxyethyl | | | |
| | Methacrylate (66/28/6 weight percent) with | | | |
| | molecular weight 370,000, 0.34 parts Coronate | | | |
| | 2203 isocyanate crosslinker manufactured by | | | |
| | Tosoh Corporation, Japan, and 1.20 parts | | | |
| | Uvinul 3050 polymer additive manufactured by | | | |
| | BASF SE, Germany | | | |

NM = not measurable

### Characterization

The beam steering performance of the integral optical constructions (including the ground plane, a dielectric, a frequency selective surface, and an attached decorative film, if used in the sample) in Examples EX-1 through EX-19 and Comparative Examples CE-1 through CE-3 were characterized using a custom-built arc setup. The arc consisted of a semi-circle having a 0.8 m radius. Transmitter and receiver horn antennas were independently positioned at various angles along the arc to record reflected beam intensity as a function of frequency. The transmitter and receiver horns were ERAVANT WR-28 Standard Gain Horn Antennas. They were connected to the two ports of a vector network analyzer (Agilent Technologies E8364C).

The dielectric properties of films in Table 1 were measured using a custom-made 24.7 GHz split-post dielectric resonator (SPDR) coupled to a Keysight N5290A vector network analyzer (VNA), conforming to the IEC 61189-2-721 standard. The VNA's input/output ports were connected via coaxial cables to input/output loop probes, which coupled to two cylindrical dielectric posts separated by 0.4 mm in a conductive cylindrical cavity. The cavity's resonant frequency and Q-factor were measured both with and without the sample film in place, and a numerical simulation was used to calculate the sample's dielectric constant (Dk) and dielectric loss tangent (Df). Effective, in this case, refers to a single Dk and Df value, even for films with multi-layered constructions. This approach is justified when the film sample's layer thicknesses are much smaller than the electromagnetic wavelength, which is true for the presented examples at 24.7 GHz. The lateral dimensions of the samples were 20 mm×40 mm, and average thicknesses were calculated from micrometer measurements across the electromagnetically active area of each sample.

For FILM R, dielectric properties were measured prior to sputter coating of one side with Al.

Samples/Examples. For Sample 1, the frequency selective surface was prepared by Patterning Method A, described below, on the side not coated with aluminum. For Sample 2, the frequency selective surface was prepared by the Patterning Method B, described below, and FILM P was used as the ground plane. For Sample 3, the frequency selective surface was prepared by Patterning Method C, described below, and the ground plane was prepared by laminating a 24 μm thick Aluminum foil available under the trade designation 3540 ULTRA-CLEAN SUPREMIUM ALUMINUM FOIL from Traceable Products, Webster, TX, to the frequency selective surface with a 20 μm PSA adhesive using a hot roll laminator.

For Samples 1 and 2, the metaelement was a circle or square, as indicated in Table 2b. For Sample 3, the metaelement type was a circular annulus. Metaelement dimensions and spacing are described for Samples 1 through 3 in Table 2b. For all samples, metaelements were arranged in a square lattice, in which the lattice period indicated in Table 2b indicates the center-to-center distances between elements both in the x- and the y-directions.

For Samples 2 and 3, a frequency selective surface was prepared and laminated to a ground metallic layer as indicated in Table 2a. Layers of samples 2 and 3 were laminated using PSA.

### Patterning Method A: Flexographic Printing

A pattern of an aqueous nanosilver ink (Novacentrix PFI-722 Conductive Silver Ink) of the desired metasurface antenna design was flexographically printed onto the uncoated surface of FILM R, which had a vacuum-coated conductive aluminum layer 90-110 nm thick on the coated surface. The aqueous nanosilver ink was printed at a speed of 20 ft/min (6.1 m/min) targeting a wet film thickness of 0.25-1.0 μm using a 2.5 BCM/in2 (0.3875 BCM/cm2) anilox roll and a 0.067 in (0.17 cm) thick flexographic polymer printing plate (MacDermid LUX ITP60 Photopolymer plate) prepared with the metasurface antenna pattern indicated in Table 2b. The printed substrate was then transported through an IR oven followed by an air impingement oven set to 280° F. (138° C.) in order to solidify the ink and sinter the silver nanoparticles.

### Patterning Method B: Printed Pattern Demetalization

A negative pattern of the metasurface antenna design indicated in Table 2b was printed on polyester film using a gravure press with water-soluble ink. The printed surface was coated with a continuous layer of aluminum using a vapor deposition process. The vapor coated surface was washed with water to remove the water-soluble printed pattern and aluminum from those areas, leaving the metasurface antenna pattern. An anti-corrosion layer was coated over the pattern demetallized film side.

### Patterning Method C: Optical Lithography and Etching Method

Film substrate was prepared by sputter coating a tie layer and copper seed layer onto an optical grade, heat stabilized PET film. The patterned resonator structures indicated in Table 2b were prepared by electroplating the sputtered/seeded film substrate with 5 microns of copper. The exposed copper was then vacuum laminated with a layer of photoresist. The photoresist was exposed by laser direct imaging and then the unexposed regions were developed. The patterned photoresist served as a mask in a copper etching step using a cupric chloride etchant, followed by an electroless tin finish plating.

TABLE 2a
Samples construction

| Sample | Sample 1 | Sample 2 | Sample 3 |
|---|---|---|---|
| Layer 1 | Metalized PET | Ground plane/ | Al foil [24 μm] |
| (bottom) | (FILM R) | PET[50 um] | |
| | [127 um]/FSS | (FILM P) | |
| Layer 2 | | PSA[20 um] | PSA [20 um] |
| Layer 3 | | PET [50 um]/FSS | DLLP[1750 um] |
| Layer 4 | | | PSA [20 um] |
| Layer 5 | | | FSS/PET [127 um] |

TABLE 2b
Samples ground plane and FSS structure

| | Frequency Selective Surface | | | | |
|---|---|---|---|---|---|
| | | Number of | | | |
| | Meta- | elements | Outer | Lattice | Wire width |
| | element | in a unit | size | period | (for rings) |
| Samples | type | cell | [μm] | [mm] | [mm] |
| 1 | Circle | 4 | 0.7, | 3.796 | N/A |
| | | | 3.328, | | |
| | | | 3.401, | | |
| | | | 3.481 | | |
| 2 | Square | 4 | 0.5, | 3.796 | N/A |
| | | | 2.803, | | |
| | | | 2.847, | | |
| | | | 2.909 | | |
| 3 | Circular | 6 | 0.826, | 1.925 | 40 (5 um thick) |
| | Annulus | | 1.519, | | |
| | | | 1.591, | | |
| | | | 1.634, | | |
| | | | 1.681, | | |
| | | | 1.795 | | |

N/A = not applicable

For Examples EX-1 through EX-19, integral optical constructions were prepared by laminating a decorative cover layer indicated in Table 3 to the frequency selective surface of a Sample 1 through Sample 3, as indicated in Table 3. Characterization results for Examples EX-1 through EX-19 and Comparative Examples CE-1 through CE-3 are presented in Table 4.

TABLE 3
Examples

| Example or | | θₐᵣᵣ | Decorative |
|---|---|---|---|
| Comparative Example | Sample | [deg] | Cover Layer |
| CE-1 | 1 | 45 | N/A |
| EX-1 | 1 | 45 | FILM A |
| EX-2 | 1 | 45 | FILM B |
| EX-3 | 1 | 45 | FILM C |
| EX-4 | 1 | 45 | FILM D |
| EX-5 | 1 | 45 | FILM E |
| EX-6 | 1 | 45 | FILM F |
| EX-7 | 1 | 45 | FILM G |
| EX-8 | 1 | 45 | FILM H |
| EX-9 | 1 | 45 | FILM I |
| EX-10 | 1 | 45 | FILM J |
| EX-11 | 1 | 45 | FILM K |
| EX-12 | 1 | 45 | FILM L |
| EX-13 | 1 | 45 | FILM M |
| EX-14 | 1 | 45 | FILM N |
| EX-15 | 1 | 45 | FILM O |
| EX-16 | 1 | 45 | FILM P |
| CE-2 | 2 | 45 | N/A |
| EX-18 | 2 | —/— | FILM A |
| CE-3 | 3 | 60 | N/A |
| EX-19 | 3 | 60 | FILM A |

N/A = not used

TABLE 4
Characterization

| | RL_{“+1”} | RL_{“0”} | RL_{“-1”} | f_{c}, Δf_{3 dB} |
|---|---|---|---|---|
| | (anomalous) | (specular) | (antisymm.) | [GHz] at |
| Example | [dB] | [dB] | [dB] | “+1” (anom.) |
| CE-1 | −8.6 | −5.6 | −26.4 | NA, NA |
| EX-1 | −7.6 | −6.9 | −21.9 | 28.4, 2.1 |
| EX-2 | −6.9 | −8.3 | −23.0 | 27.5, 2.2 |
| EX-3 | −8.8 | −8.0 | −21.4 | 28.0, 2.0 |
| EX-4 | −7.4 | −7.3 | −25.3 | 27.7, 1.9 |
| EX-5 | −22.3 | −0.9 | −22.9 | 28.4, 2.2 |
| EX-6 | −9.1 | −7.2 | −22.5 | 28.0, 2.0 |
| EX-7 | −7.8 | −7.7 | −21.5 | 28.0, 2.0 |
| EX-8 | −7.3 | −7.9 | −21.9 | 28.0, 1.9 |
| EX-9 | −7.0 | −7.5 | −26.3 | 27.9, 2.0 |
| EX-10 | −9.4 | −5.4 | −21.6 | NA, NA |
| EX-11 | −6.8 | −7.8 | −22.2 | NA, NA |
| EX-12 | −7.6 | −7.1 | −22.0 | 29.9, 3.0 |
| EX-13 | −7.1 | −8.4 | −23.5 | 29.0, 2.4 |
| EX-14 | −7.7 | −8.6 | −20.6 | 30.0, 3.0 |
| EX-15 | −19.6 | −2.3 | −19.4 | 30.4, 2.4 |
| EX-16 | −22.1 | −1.8 | −23.3 | 30.0, 2.6 |
| CE-2 | −12.6 | −6.1 | −22.4 | 30.4, 2.6 |
| EX-18 | −12.0 | −4.2 | −21.0 | 30.2, 2.7 |
| CE-3 | −9.0 | −0.5 | −12.4 | NA, NA |
| EX-19 | −11.3 | 0.5 | −16.2 | 28.4, 2.1 |

What is claimed:

1. An integral optical construction comprising at least one frequency selective reflective construction disposed between a decorative cover layer and a ground metallic layer, the decorative cover layer configured to display at least one of an image and information to a viewer, the ground metallic layer configured to substantially at least one of reflect and absorb a radiofrequency (RF) electromagnetic wave transmitted by the decorative cover layer and the at least one frequency selective reflective construction, each of the at least one frequency selective reflective constructions comprising:
a frequency selective surface (FSS) layer disposed on a multilayer stack and comprising a group of metallic elements repeating across the FSS layer to form an array of the group of metallic elements, the multilayer stack comprising a plurality of alternating different first dielectric and second adhesive layers; wherein
the integral optical construction is configured to reflect, by one of constructive and destructive interference, a substantially collimated incident RF electromagnetic wave having a free-space wavelength in a range from about 1.0 mm to about 10 cm and incident at an incident angle as a substantially collimated reflected wave at a reflected angle different from the incident angle, and wherein for a substantially normally incident light having a first visible wavelength in a visible wavelength range extending from about 420 nm to about 680 nm, the at least one frequency selective reflective construction has an optical transmittance of greater than about 50%.

2. The integral optical construction of claim 1, wherein the ground metallic layer is physically and electrically continuous across the integral optical construction, such that for a substantially normally incident light having the first visible wavelength, the ground metallic layer has an optical transmittance of less than about 20%.

3. The integral optical construction of claim 1 having an optical transmittance of greater than about 50% for a substantially normally incident light having the first visible wavelength.

4. The integral optical construction of claim 1, wherein for a substantially normally incident light having the first visible wavelength, the decorative cover layer has an optical transmittance of greater than about 50%.

5. The integral optical construction of claim 1, wherein the ground metallic layer is a metallic mesh layer, the mesh comprising a plurality of metal traces connected to form a plurality of enclosed open areas, such that for a substantially normally incident light having the first visible wavelength, the ground metallic layer has an optical transmittance of greater than about 50%.

6. The integral optical construction of claim 1, wherein the at least the image displayed by the decorative cover layer comprises one or more of a blue color, a black color, a white color, a green color, a yellow color, a brown color, and a red color, and any other color that may at least partially be visible to the viewer.

7. The integral optical construction of claim 1, wherein the at least the image displayed by the decorative cover layer comprises an image of one or more of an object, a solid color, a pattern, a scenery, a person, and an animal.

8. The integral optical construction of claim 1, wherein the at least the image displayed by the decorative cover layer comprises at least one of a logo, a map, a sign, and a symbol.

9. The integral optical construction of claim 1, wherein the at least the information displayed by the decorative cover layer comprises one or more of a letter, a word, and a number.

10. The integral optical construction of claim 1, wherein the at least one frequency selective reflective construction comprises at least two frequency selective reflective constructions.

11. The integral optical construction of claim 10, wherein the groups of metallic elements in the at least two frequency selective reflective constructions are aligned with each other in a one-to-one correspondence.

12. The integral optical construction of claim 11, wherein the metallic elements in the aligned groups of metallic elements in the at least two frequency selective reflective constructions are aligned with each other in a one-to-one correspondence.

13. The integral optical construction of claim 1, wherein the metallic elements in the group of metallic elements form a regular array of the metallic elements.

14. The integral optical construction of claim 1, wherein the array of the group of metallic elements is a regular array.

15. The integral optical construction of claim 1 configured to be attached to a support surface so that the decorative cover layer faces away from the support surface.

16. The integral optical construction of claim 15, wherein the support surface is an exterior surface of a rigid support.

17. The integral optical construction of claim 16, wherein the rigid support is a wall, a door, or a window of a building.

18. The integral optical construction of claim 17, wherein the wall is one of a ceiling wall, a floor wall, or a side wall.

19. A construction comprising the integral optical construction of claim 1 attached to rigid support so that the decorative cover layer faces away from the rigid support.

20. The construction of claim 19, wherein the rigid support is a wall, a door, or a window of a building.
